(19) United States
(12) Patent Application Publication
(10) Pub. No.: US 2026/0120300 A1
(43) Pub. Date: Apr. 30, 2026

(54) COMMON IMAGE SPACE FOR IMAGE REGISTRATION

(71) Applicant: Siemens Healthineers AG, Forchheim (DE)

(72) Inventor: Elisabeth Preuhs, Erlangen (DE)

(21) Appl. No.: 19/367,416

(22) Filed: Oct. 23, 2025

(30) Foreign Application Priority Data
Oct. 25, 2024 (DE) 10 2024 210 300.4

(51) Int. Cl. G06T 7/30; G06V 10/82

(52) U.S. Cl. CPC G06T 7/30; G06V 10/82

(57) ABSTRACT

A method for training an algorithm for machine learning by providing a first input image dataset and a second input image dataset, transforming the first input image dataset into a first output image dataset and the second input image dataset into a second output image dataset, in each case by the algorithm, wherein the two output image datasets belong to a common image space with a predetermined image point resolution and/or a predetermined contrast range, and optimizing the algorithm such that: firstly, a difference measure relating to a difference between the two output image datasets or their representations in a latent space used during transformation is minimized and secondly, a sum of image point values of each output image dataset is maximized.

### CROSS REFERENCE TO RELATED APPLICATIONS

This application claims the benefit of DE 102024210300.4 filed on Oct. 25, 2024, which is hereby incorporated by reference in its entirety.

### FIELD

Embodiments relate to a method for training an algorithm for machine learning by providing a first input image dataset and a second input image dataset and transforming the first input image dataset into a first output image dataset and the second input image dataset into a second output image dataset, in each case by the algorithm.

### BACKGROUND

In association with medical imaging data, comparisons and/or the registration of/between two or more datasets of a patient are often required. The most important examples in this field are (but not restricted to): comparisons of two (or more) successive recordings (e.g. observing the growth of a structure, for example, a tumor), registration of preoperative data (e.g. diagnostic scans such as 3D-CT (computed tomography) data or MR (magnetic resonance tomography) data) to operative data (e.g. during a minimally invasive intervention) in order to visualize the exact positions of structures that are not visible in the operative data, but are visible in the preoperative data (e.g. calcifications on vascular walls that are not readily visible in interventional image data recorded with a C-arm but are readily visible in preoperative 3D-CTA (CT angiography) data), and registration/fusion of patient data from different modalities, for example, MR data with PET (positron emission tomography) data in order to increase the diagnostic value.

The most important technology that enables the aforementioned examples is image registration which is required in order to calculate the relationship between one or more datasets-whether 2D, 3D and/or 4D data-and to configure the data geometrically so that the same structures in one dataset are placed upon another dataset in order to simplify the evaluation or the comparison.

Image registration is a known problem in medical imaging. In general, a registration pipeline consists of the following steps: the two images for registration are designated fixed and movable (in the following also the first and the second input image dataset or vice versa). The movable image is transformed/moved in the course of the registration until it is aligned with the fixed image. The fixed and movable images are compared with the aid of a metric which evaluates how similar (i.e. how well aligned) the images are. The simplest metric would be the calculation of a difference image wherein the sum of all the image point values=0 would mean that the images are completely identical, that is, perfectly aligned. The result of this metric is used for the optimizer which proposes a transformation (rigid and/or non-rigid). This transformation is applied to the movable image and the procedure is repeated until the end criteria are met (e.g. when the metric value has reached a minimum).

There is a plurality of algorithms that are based upon different techniques for different data. Dependent upon the specific data, different metrics are also involved. A summary of the different algorithms is set out in Hermessi, Haithem, Olfa Mourali and Ezzeddine Zagrouba's “Multimodal medical image fusion review: Theoretical background and recent advances”; Signal Processing 183 (2021): 108036.

A summary of the algorithms that include deep learning is set out in Fu, Yabo et al. “Deep learning in medical image registration: a review.” Physics in Medicine & Biology 65.20 (2020): 20TR01 and also in Haskins, Grant, Uwe Kruger, and Pingkun Yan. “Deep learning in medical image registration: a survey.” Machine Vision and Applications 31.1 (2020): 8.

However, it is not easy to design an (automated) registration metric, for example, if different modalities are involved. In many cases, the registration is highly specialized and is difficult to transfer to other modalities or even just to other body parts.

From the article by Alexey Dosovitskiy, Lucas Beyer, Alexander Kolesnikov, Dirk Weissenborn, Xiaohua Zhai, Thomas Unterthiner, Mostafa Dehghani, Matthias Minderer, Georg Heigold, Sylvain Gelly, Jakob Uszkoreit and Neil Houlsby; “AN IMAGE IS WORTH 16X16 WORDS: TRANSFORMERS FOR IMAGE RECOGNITION AT SCALE”, published as a conference paper at ICLR 2021 (International Conference on Learning Representations), https://arxiv.org/pdf/2010.11929, a so-called vision transformer is known. It is based upon transformer architecture which has become the de facto standard for processing tasks in natural language and are now planned to be implemented for computer vision. For the application of transformer architecture to images, the respective image is divided into patches (partial images) and a sequence of these patches is provided as input for a transformer. Image patches are handled exactly like tokens (words) in an NLP (natural language processing) application. The model is trained for image classification in a supervised manner.

Furthermore, from the article by Carl Doersch; “Tutorial on Variational Autoencoders”; https://arxiv.org/pdf/1606.05908; June 2016, a variational autoencoder is known. According to this, variational autoencoders (VAEs) are one of the most favored approaches for unsupervised learning applied to complicated distributions. VAEs are based upon standard function approximators (neural networks) and may be trained using stochastic gradient descent.

In addition, the article by Ashish Vaswani et al.: “Attention Is All You Need”; 31st Conference on Neural Information Processing Systems (NIPS 2017), Long Beach, CA, USA; https://user.phil.hhu.de/˜cwurm/wp-content/uploads/2020/01/7181-attention-is-all-you-need. pdf describes in detail so-called transformers and the attention mechanism.

Furthermore, the article by Gao, Cong et al. “Synthetic data accelerates the development of generalizable learning-based algorithms for X-ray image analysis.” Nature Machine Intelligence 5.3 (2023): 294-308 how synthetic 2D X-ray images are generated from a 3D dataset.

### BRIEF SUMMARY AND DESCRIPTION

The scope of the present disclosure is defined solely by the claims and is not affected to any degree by the statements within this summary. The present embodiments may obviate one or more of the drawbacks or limitations in the related art. Independent of the grammatical term usage, individuals with male, female or other gender identities are included within the term.

Embodiment provide measures with which the registration of images to one another may be simplified including a method for training an algorithm for machine learning, a method for registering output image datasets and an imaging system and a computer program.

According to an embodiment, a method is provided for training an algorithm for machine learning by providing a first input image dataset and a second input image dataset, transforming the first input image dataset into a first output image dataset and the second input image dataset into a second output image dataset, in each case, by the algorithm, wherein the two output image datasets belong to a common image space with a predetermined image point resolution and/or a predetermined contrast range, and optimizing the algorithm such that: firstly, a difference measure relating to a difference between the two output image datasets or their representations in a latent space used during transformation is minimized and secondly, a sum of image point values of each output image dataset is maximized.

An algorithm for machine learning is a process that enables computer systems to recognize patterns and relationships from data without having been explicitly programmed. This typically includes of three main components: a model that represents the underlying relationships between inputs and outputs; a training phase in which the model is adapted on the basis of example data; and a test phase in which the performance of the model is evaluated. These algorithms are used widely in fields such as computer vision, speech recognition and many others. For the training, by way of example, supervised learning, unsupervised learning and reinforcement learning are possible. As models, for example, linear regression, support vector machines, artificial neural networks, generative adversarial networks and such like may be used.

Input image datasets are provided. These input image datasets represent recordings, that is, images that are intended to form a basis for a mutual registration. For example, as the first input image dataset, an image dataset from an MR recording and as the second input image dataset, an image dataset from an X-ray recording are provided. Since an X-ray recording and an MR recording typically have different sizes and contrasts, it is difficult to register them to one another.

A provision of data, for example, of the input image datasets may be understood here and in the following as meaning, for example, that it includes or consists of an acquisition or reading out of the data from a data store or a database. The provision of the data may also include or consist of the receiving of a data stream in which the data is contained. The provision of the data therefore does not necessarily include the generation or recording of the data. In some embodiments, however, the provision of the data may, however, also include the generation or recording of the data.

In a further step, the transformation of the input image datasets (that is, datasets at the input of the algorithm or network) to output image datasets (i.e. datasets at the output of the algorithm and/or network) takes place by the algorithm in each case. The transformation means that the input image datasets are automatically transformed into the output image datasets. The algorithm therefore processes the image datasets in order to be able to register the corresponding images to one another better. For example, the input image datasets are transformed into a common image space. The common image space is distinguished by a predetermined image point resolution and/or a predetermined contrast range. In one variant, the output image datasets in the common image space therefore have the same image point resolution. The two output image datasets and/or the images they represent possibly have the same size and the same image point count. Alternatively or additionally, the common image space may be defined in that it specifies or predetermines an identical contrast range for both output image datasets. The entire contrast range from white to black may be utilized. However, the contrast range may also be restricted for both output image datasets. Under some circumstances, the common image space is also characterized in that it specifies an identical mean brightness for both output image datasets. Alternatively or additionally, the common image space may also be defined in that it specifies the same image point values for the same structures. In this way, it could be ensured that, for example, bones are always shown as white.

The algorithm is optimized during the course of the training. For this purpose, the difference or a corresponding difference measure between the output image datasets or their representations in a latent space used during transformation is minimized. The difference measure may be a difference image or, for example, also a total of the image point values of the difference image or may be based thereon. In one variant, it is not the difference of the output image datasets that is formed, but rather a difference between representations of the output image datasets in a latent space that is used in the transformation. For example, the transformation is realized by way of an encoding and decoding. Therein, the input image datasets are encoded into a latent space and decoded out of this space again to output image datasets, i.e. to datasets at the output of the algorithm or network. It may be advantageous to minimize the difference as early as in the latent space.

In addition, during the optimizing of the algorithm, a maximizing of a respective sum of image point values of each output image dataset takes place. This maximizing of the image point values has the purpose that, during optimizing of the algorithm, the structures of the input images into the corresponding output images are not lost and are possibly even reinforced.

An image point may be understood above and in the following, dependent upon the dimension of the corresponding dataset to which reference is made, to be a two-dimensional region, that is, a pixel, or a three-dimensional volume, that is, a voxel.

By way of the training method, an algorithm may be provided that may produce output image datasets aligned with each other, from corresponding input image datasets. Such an algorithm may represent the basis for a comfortable registration of output images or their output image datasets to one another.

In an embodiment, the optimization of the algorithm takes place on the basis of the following formula:

argminL(θ)−λR(I₁)−λR(I₂),
where L is a loss function of weights θ of the algorithm, R( ) is a regularization function, λ is a regularization parameter, and I₁, I₂ are the output image datasets of the common image space.

According to this formula, the error, represented by the loss function L, is minimized. The training therefore takes place according to a gradient descent method. The regularization function R serves for avoiding an overfitting during training of the model or algorithm. With this regularization function, it may be achieved, for example, that the total of the image point values of an output image dataset is maximized. The regularization parameter λ enables influence to be exerted over how important it is to reach a maximum value in the image point total. If the regularization parameter is selected to be, for example, very small (e.g. 0.01), the corresponding output image will hardly exhibit any structures. If, however, the regularization parameter is selected higher (e.g. 0.9), the output image will have correspondingly more structures.

In an embodiment, it is provided that the algorithm for transforming the first input image dataset into the first output image dataset and the second input image dataset into the second output image dataset includes a vision transformer model wherein image subregions of the respective input image dataset are encoded by a transformation encoder into encoded datasets of a latent space and the encoded datasets are decoded by a transformation decoder into the respective output image dataset.

A vision transformer (ViT) model is a deep learning model that applies the transformer architecture with an integrated attention mechanism to image recognition tasks. In contrast to conventional CNNs (convolutional neural networks), that acquire local features in images by way of overlapping windows, ViT divides the input image into a fixed grid of irregular non-overlapping patches (image subregions) and treats each patch as a “word” in the transformer architecture. These patches are then combined with positional embeddings and fed through the transformer layers in order to acquire, for example, global features and/or to carry out classification tasks. ViT has proved to be very effective for large scaled image recognition tasks and with sufficiently large datasets, often achieves better performance levels than conventional CNNs. With regard to more detailed functions and structures of a vision transformer, reference should be made to the aforementioned article by Alexey Dosovitskiy.

Thus the transformation encoder encodes the image subregions or their datasets of the two input image datasets into corresponding representations in the latent space. The transformation decoder of the vision transformer model then decodes the representations in the latent space to the two output image datasets in the common image space. Finally, from these two output image datasets, corresponding output images and/or a corresponding difference image or a corresponding difference measure may be determined.

According to a further embodiment, it is provided that the algorithm for transforming the first input image dataset into the first output image dataset and the second input image dataset into the second output image dataset includes a variational autoencoder.

A variational autoencoder (VAE) is a generative deep learning model that enables the use of a Bayesian method in the autoencoder architecture. VAEs learn a probabilistic and continuous latent representation of the input data in that they model the probability distribution over the data space, by which means they may generate effective new and realistic-seeming data.

With regard to the functioning and structure of variational autoencoders, reference should be made to the article by Carl Doersch mentioned in the introduction.

By way of example, the variational autoencoder architecture may have an encoder on the input side for each input image dataset. The resulting codes may be used as an input variable for a common encoder that encodes a corresponding vector in the latent space. This vector is decoded by way of a common decoder. Respective decoded image components are fed to two individual encoders as input variables that therefrom ultimately decode the two output image datasets into a common image space. From these output image datasets, a difference image may again be obtained.

According to a further embodiment, the algorithm for machine learning is pretrained with pairs of input image datasets registered to one another and associated output image datasets registered to one another. The two output image datasets registered to one another may already be situated in the common image space. Such a pair of input image datasets for the pretraining may originate, for example, from different imaging modalities or temporally sequentially or may have been recorded from different angles. A corresponding output image dataset belongs to each input image dataset. The two output image datasets that are registered to one another form the output data for training the algorithm, whereas the input image datasets that are registered to one another form the input data for training the algorithm. The output image datasets may correspond to real or synthetic images. The pretraining may take place with a large number of training sets that each consist of two mutually registered input image datasets and two mutually registered output image datasets (each on the basis of, for example, a specialized registration method and/or manual registration). The network or the algorithm learns to transfer the different datasets into the same space. The registration takes place outside the network. In the application, the input datasets cannot be registered to one another and by way of the corresponding difference image/measure at the output, the corresponding non-matching is mapped. During training, the aim is that the difference measure at the output is 0, for which purpose, the items of data at the input must be registered to one another. After the pretraining, a fine tuning or optimization of the algorithm may take place, as described above.

In a further embodiment, it is provided that the first input image dataset and the second input image dataset are generated from different imaging modalities. As previously mentioned, the input image datasets may be obtained from imaging modalities such as MR devices, X-ray devices (CT device, angiography device, C-arm device, etc.), ultrasound device and suchlike. The image datasets generated by the different imaging modalities typically have different formats, different sizes, different contrasts, etc. Such images from two different imaging modalities may now be more easily and better registered to one another.

According to a further embodiment, the first input image dataset and the second input image dataset are generated at different time points. For example, the first input image dataset is created preoperatively and the second input image dataset is created intraoperatively. In these cases also, typically, a registration of the respective images or input image datasets is necessary because, for example, the patient has moved in the meantime or because the patient was positioned differently (e.g. on the front instead of on the back), or because the table position is different. The algorithm for the registration may thus be trained for this aspect of the time difference.

In a further embodiment, it is provided that the first input image dataset and the second input image dataset correspond to simulated datasets that are simulated according to different imaging modalities.

According to a further embodiment, it is provided that the first input image dataset and the second input image dataset are generated from different recording angles. If, for example, a first X-ray image recording is obtained before the operation from a first recording angle and a second X-ray image is obtained during the operation from a different recording angle, in this case also, the two recorded images should be able to be registered to one another. In this case, the algorithm may learn to recognize identical structures in the two images so that the output image datasets generated therefrom may be registered to one another. When using different imaging modalities, the input images are typically also obtained from different recording angles. The recording angle herein means a particular solid angle in a common coordinate system for both the input images or input image datasets.

In a further embodiment, the difference measure corresponds to a sum of all the differences of image point values of mutually corresponding image points of the output image datasets. Thus, in effect, a difference image is obtained from the first output image dataset and the second output image dataset, and the sum of all the image point values of this difference image represents the difference measure. A one-dimensional difference measure of this type permits a very efficient optimization of the algorithm.

In a further embodiment, the algorithm is pretrained with input image datasets from different imaging modalities and/or different subregions of an object to be mapped. The algorithm may thus be trained very broadly (on different imaging modalities and different subregions of an object) or very specifically only on different imaging modalities or only on different subregions of an object to be mapped. Both training methods for the pretraining may be advantageous in a case-specific manner. For example, the training with different subregions of the object to be mapped may be advantageous with patients. For example, different body regions of a patient may thus be learned, as is advantageous if, for example, a catheter is to be pushed from the groin into the head and a continuous imaging accompaniment is desired.

Embodiments further provide a method for registering a first output image dataset with a second output image dataset, wherein the first output image dataset is generated from a first input image dataset and the second output image dataset is generated from a second input image dataset with an algorithm that is trained with a method according to the above description. The algorithm trained as described above is thus used for the registration of the two output image datasets. In other words, the two output image datasets are registered to one another with the algorithm specifically trained according to the invention. In this way, a very efficient and reliable registration of the output image datasets may take place.

In an embodiment, it is provided that the registration takes place iteratively in that a registration difference measure between the output image datasets is calculated and a position size of one of the output image datasets is changed until the registration difference measure is a minimum. Thus, during the registration process (after the training), a unique registration difference measure is determined in relation to the two output image datasets that are to be registered to one another. For example, a difference image dataset or a difference image is obtained between the two output image datasets that are to be registered. The difference image obtained (also substituting for the difference image dataset) may itself be the registration difference measure or however, for example, the total of all the image point values of the difference image is again used as the registration difference measure. Provided the algorithm is already able, in its trained form, to generate a difference measure for the two output image datasets, this difference measure may be used for the iterative registration. In the registration, a position size (e.g. one or more spatial coordinates) of one of the output image datasets is changed. In a specific example, an output image is displaced by two image points to the right. In each iteration step, the registration difference measure is then recalculated. Such a displacement of the output image is carried out for as long as the registration difference measure between the two output image datasets to be registered to one another is a minimum. Therefore, during the iterative registration, the transformation of the input image datasets to the output image datasets and the calculation of the registration difference measure is carried out multiple times one after the other until a corresponding convergence is achieved.

In a further embodiment, the algorithm provides the difference measure for the registration as a registration difference measure. This was previously indicated above. It is then not necessary, for the registration, that the registration difference measure is separately calculated anew, since this difference measure occurs, in practice, during the transformation as a “waste product”.

Embodiments further provide an imaging system with an image processing facility that is configured to carry out a method as described above. The image processing facility may have, for example, a computer or one or more processors and one or more storage units in order to be able to carry out the method. The advantages and development possibilities set out above in relation to the method apply similarly also to the imaging system. The method features mentioned are then to be interpreted as corresponding functional features.

In an embodiment, the imaging system has two different imaging modalities, each of which provides one of the input image datasets. The imaging system may thus, for example, have the modalities MR device and C-arm or the modalities angiography system and ultrasound system or such like. However, the imaging system is not restricted to the aforementioned pairs of imaging modalities. Rather, the imaging system may also be equipped with any other desired pairs of imaging modalities. Each imaging modality then makes its own input image dataset available for the training and/or the registration.

Embodiments further provide a computer program that includes instructions that, when the program is executed by an aforementioned imaging system, cause it to carry out the method also described above. In the same way, a computer program product (e.g. a portable memory store) is provided that includes these instructions.

### BRIEF SUMMARY OF THE FIGURES

FIG. 1 depicts a transformer architecture and the training for a common image space according to an embodiment.

FIG. 2 depicts a variational autoencoder architecture and the training for a common image space according to an embodiment.

FIG. 3 depicts a schematic illustration of an imaging system according to an embodiment.

### DETAILED DESCRIPTION

A very simple and expressive metric for the registration of two (medical) images or image datasets (in the present document, both expressions are used synonymously provided not otherwise stated) is the difference between a first image (hereinafter also called a fixed image) and a second image (hereinafter also called a movable image). For the registration of two images, it is sufficient under some circumstances if only image subregions are registered to one another. A difference image with values of 0 means that both images (in the present document also representative for image subregions) are identical-that is, perfectly aligned and therefore registered. In this way, the difference metric may be interpreted as quantitative since its values correlate directly with the actual difference. This metric may, however, only be used if the two images originate from the same modality and have the same imaging properties and the same visualization for different mapped parts, for example, vessels with calcifications. Otherwise, this metric provides values that cannot be interpreted. For multimodal image registration, this metric is not usable and more complex metrics must be made use of. According to the invention, algorithms for machine learning or AI (artificial intelligence) models are therefore used in order to simplify the process of comparing two images during the registration, in that the difference metric is also used for images from different modalities.

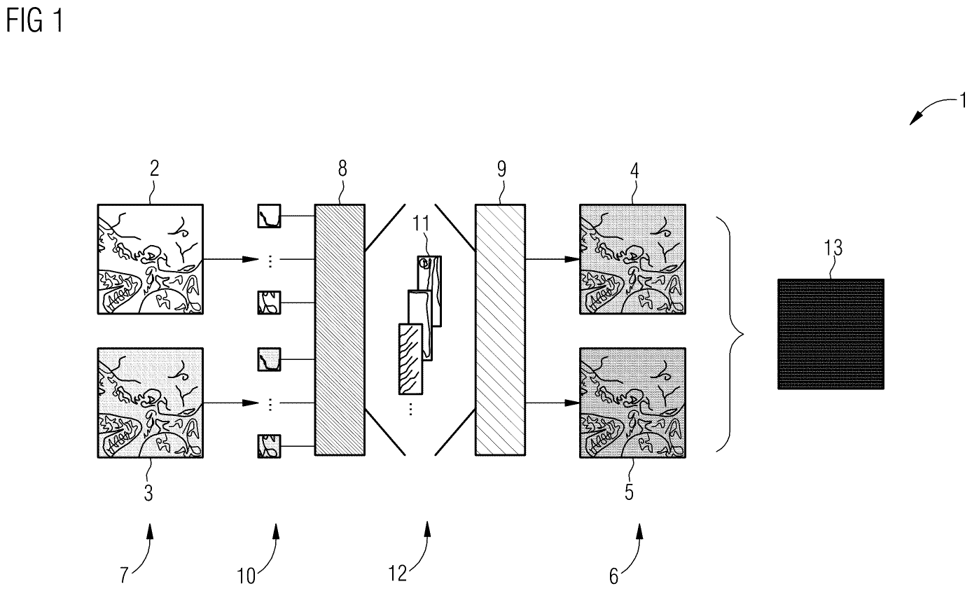

For example, (generative) AI models (short for any type of algorithm for machine learning) may be integrated into the multimodal image registration in order to simplify the metric. A possible registration pipeline looks as follows (see FIG. 1): Converting the static and moving images (first and second input image datasets) into the so-called common image space making use of a (generative) AI model before the registration (see below for further details) and (Iterative) image registration as described above making use of this simple difference metric of the two images from the common image space.

The images are transferred to a so-called common image space. In this space, the properties and tissue that are mapped in the original image (fixed or moving) are retained, but the style or the format of the images is different; it is aligned so that they are as similar as possible. The common image space is therefore a space that is independent of typical image properties that, for example, are unique to a specific device manufacturer or an imaging modality. Thus, for example, two input images of the same patient and the same body region, for example, MR and CT, are straightened out so that they are as similar as possible in the common image space. In this way, two images from different modalities are “exactly identical” in the common image space if they are optimally matched to each other, that is, the difference metric for these images is 0 (or as close to 0 as possible). This means that the registration of images from this common image space is possible with the aid of the simple difference metric.

One possibility for realizing the common image space is a vision transformer model (see the article by A. Dosovitskiy et al.) the architecture of which is shown in FIG. 1. This vision transformer 1 takes two images (input image datasets 2, 3) as the input and outputs two other images (output image datasets 4, 5). The input images 2, 3 consist of two images that are used for the registration (or to which the registration is to be applied); they show, for example, the same body region or the same area, but with two different recording or viewing angles, for example, from two different modalities or at two different time points. The result is two images 4, 5 that are situated in the common image space 6.

By way of the use of the architecture of a vision transformer 1 and its attention mechanisms, the network may learn which image features and characteristics occur in the two spaces 7 of the input images 2, 3, what they have in common and how the features from one image space 7 (input image space) correlate with those from the second image space 6 (output image space or common image space) in order to generate the common image space representation for both the output images 4, 5. In this case, the encoder 8 is heavily weighted (i.e. with a plurality of layers and learnable parameters) in order to encode all the relationships between the two input image spaces 7. The decoder 9 may be lightly weighted since the task of the decoder 9 consists in transforming the learned representations into output images 4, 5 preferably of the same size as the input images 2, 3.

The vision transformer 1 may also be trained with a so-called masking technology with which the input images 2, 3 are masked (i.e. a particular part of the input patches 10 is removed) in order to improve the performance. In this way, the transformer 1 is forced to concentrate only on the most important features or patterns in the images.

A specific training structure may thus look as follows according to FIG. 1: a first input image dataset 2 according to a first input image is provided by a first modality. Furthermore, a second input image dataset 3 corresponding to a second input image is provided by a second modality. Each input data image originates from its own input image space 7. Each of the two input images is disassembled into image subregions or patches 10 and is made available to a vision transformer encoder 8 at the input. Therefrom, the vision transformer encoder 8 generates representations 11 (e.g. datasets) in a latent space 12. These representations 11 are made available to a vision transformer decoder 9 for decoding. It generates therefrom the output images 4, 5 or the corresponding output image datasets in the common image space 6. For the training, a difference image 13 may be formed from the output images 4, 5. The training aim may be that as far as possible the training image 13 has the image value 0 as far as possible everywhere and the respective sums of the image point values of the output images 4, 5 are as large as possible so that the structures may be represented as rich in contrast as possible.

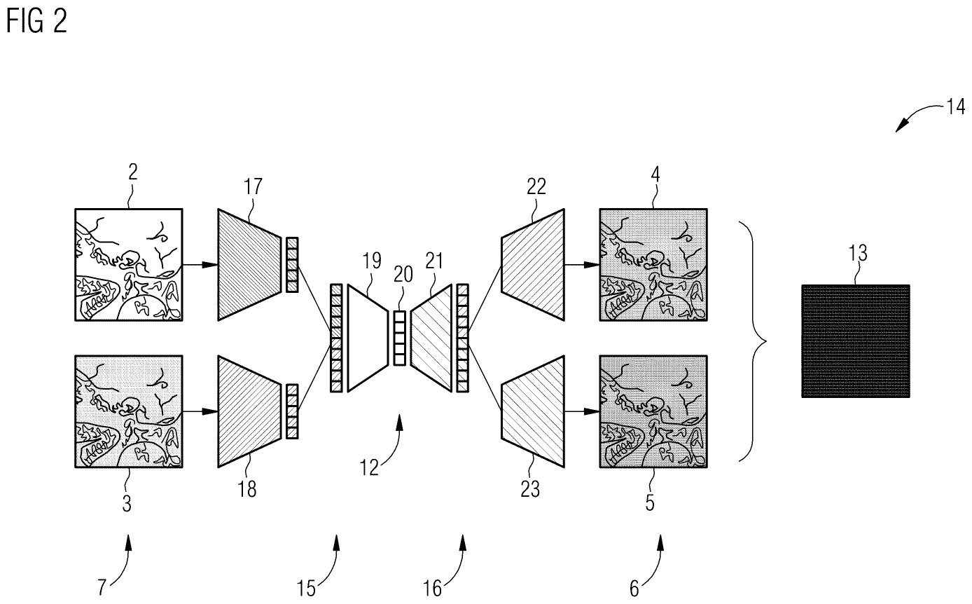

A second possibility for the architecture of an AI model or of an algorithm for machine learning is a so-called variational autoencoder 14 (see FIG. 2) that encodes similar images close to one another in the latent space. Due to its ability to encode input image datasets 2, 3 as probability distributions, the variational autoencoder 14 may also calculate new combinations from the input image datasets, that may be helpful in the decoding and generation of the output image datasets 4, 5 in the common image space 6. Similarly to the vision transformer 1, this autoencoder 14 accepts two input image datasets 2, 3 and generates two output image datasets 4, 5. However, compared with a classic variational autoencoder, the architecture must be adapted with a single input and a single output, for example, by way of the use of different encoding layers 15 at the start and different decoding layers 16 at the end, in order to encode different image spaces 7 into the latent space 12 or in order to decode different images in the common image space 6. So that the network of the AI model may learn common features and properties, the inner layers are interlinked at one point 17 in the latent space 12.

A specific training structure of a variational autoencoder for training for the common image space is represented schematically in FIG. 2. The first input image 2 that is provided, for example, preoperatively by a first modality is fed to a first encoder 17. The second input image that is obtained, for example, during an operation from a second modality, is fed to a second encoder 18. The two encoders 17, 18 each generate respective learned features that are brought together in a common encoding layer (see encoder layers 15). The common encoder layer serves as an input for a joint encoder 19. This joint encoder 19 provides a common representation 20 that is decoded by a joint decoder 21 into a common decoding layer 16. Parts of this common decoding layer 16 are then separately decoded by way of a first decoder 22 and a second decoder 23 to the output images 4 and 5 and into the common image space 6. From both the output images 4 and 5, a difference image 13 may again be obtained for training purposes.

For both the architectures, the possibility exists of calculating a difference metric directly on the latent representations 11 or 20 of the two input images 2, 3 (rather than decoding them before the calculation of the difference metric). For both the architectures, the possibility also exists of generating the difference image 13 or the difference metric directly (rather than from two images in the common image space 6).

The training of each model or algorithm may be carried out with synthetic data or previously registered data. For example, in order to realize a 3D-2D registration between preoperative CT and operative X-ray data, synthetic 2D X-ray images may be generated from the 3D dataset. By this means, the 3D data is already perfectly matched to the synthetic 2D images. The training may be realized using this precondition: the output images 4, 5 have a difference image/metric value of 0 in a common image space 6 that may be used as a loss function, that is, the training goal consists of reaching a difference metric of 0 (or as close as possible to 0). The output images must however be regulated so that they or their image point values are not 0 (that would be the simplest solution), but rather still contain the (common) structures and features. This may be achieved under the condition that the images in the common space 6 must be as far removed from 0 as possible, that is, the values in the image must be as large as possible (maximized). This may be achieved with additional regularization conditions within the loss function and their optimization during the training, specifically argminL(θ)−λR(I₁)−λR(I₂) where L is the loss function of the network weights θ, R( ) is the regularization term/function, λ is the regularization parameter (that controls the strength of the regularization) and I₁,I₂ are the output images of the common image space. Whereas the loss function (that here is a simple difference between the two output images) is minimized during the training, the output images are simultaneously maximized so that the training does not lead to the trivial solution in which the two output images are mapped to zeros, since this would result, by definition, in the minimum loss value. This loss function may be used together with both the regularization terms with both the aforementioned architectures (transformer and variational autoencoder).

The vision transformer may be trained in advance on different imaging modalities and body regions (provided these contain a sufficient number of learning-capable parameters and layers), so that the same architecture and the same network may be used for the calculation of the metrics for different modalities and body regions.

The training may also be configured so that the network already outputs only one result, for example, the (latent) difference image or a difference value.

Below, a possible application of the trained AI model or algorithm for the registration is described. In a classic iterative registration process, the steps with the network trained for the common image space are as follows: 1) Transform both images (fixed and movable) with the network into the common image space 6. 2) Calculate the difference metric from the transformed images or take the difference value from the network if it already outputs the difference value itself. 3) Perform a step of the iterative registration (optimization) (e.g. displacement). This results in a new movable image that corresponds to the old one with the registration transformation applied. Repeat steps 1) to 3) until convergence is achieved.

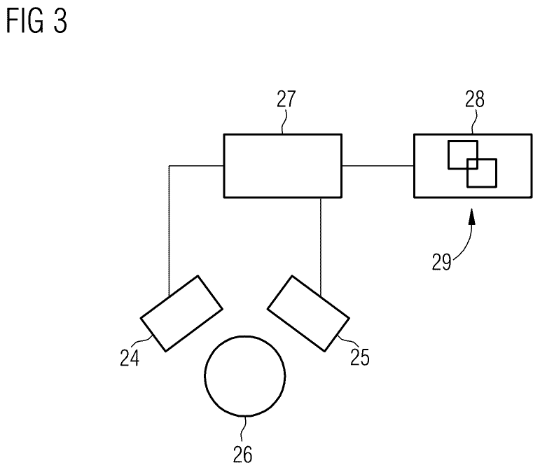

FIG. 3 depicts schematically an embodiment of an imaging system. It has two different imaging modalities that transfer corresponding images of an object 26 to an image processing facility 27 of the imaging system. The two imaging modalities 24 and 25 may be of different types. Possible types have been set out multiple times above. The image processing facility 27 may contain, for example, a vision transformer 1 trained according to FIG. 1 or a variational autoencoder 14 trained according to FIG. 2 or also another corresponding algorithm for the transformation of the input images into a common output image space. The imaging system may also have a display unit 28 according to FIG. 3 in order to display the images 29 registered to one another, based upon images from the two imaging modalities 24 and 25.

One advantage of the described embodiments is the low level of complexity in the image registration. Through the use of a network or algorithm for generating the common image space and the transfer to this network of the images to be registered, a clear and simple metric for the iterative registration process is brought about. Furthermore, no further specific metrics for each registration problem (e.g. different modalities, different body regions, 2D vs. 3D, etc.) have to be sought and designed, since the network may transform each imaging modality into the common image space. In this way, the multimodal image registration may be easily performed.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that the dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for training an algorithm for machine learning, the method comprising:
providing a first input image dataset and a second input image dataset;
transforming, by the algorithm, the first input image dataset into a first output image dataset and the second input image dataset into a second output image dataset, wherein the two output image datasets belong to a common image space with a predetermined image point resolution and/or a predetermined contrast range; and
optimizing the algorithm such that a difference measure relating to a difference between the two output image datasets or their representations in a latent space used during transformation is minimized and a respective sum of image point values of each output image dataset is maximized.

2. The method of claim 1, wherein the optimization takes place based on the following formula: argminL(θ)−λR(I₁)−λR(I₂), where L is a loss function of weights θ of the algorithm, R( ) is a regularization function, λ is a regularization parameter, and I₁, I₂ are the output image datasets of the common image space.

3. The method of claim 1, wherein the algorithm for transforming the first input image dataset into the first output image dataset and the second input image dataset into the second output image dataset includes a vision transformer model, wherein image subregions of the respective input image dataset are encoded by a transformation encoder into encoded datasets as representations of a latent space and the encoded datasets are decoded by a transformation decoder into the respective output image dataset.

4. The method of claim 1, wherein the algorithm for transforming the first input image dataset into the first output image dataset and the second input image dataset into the second output image dataset includes a variational autoencoder.

5. The method of claim 1, wherein the algorithm is pretrained with pairs of input image datasets registered to one another and associated output image datasets registered to one another.

6. The method of claim 1, wherein the algorithm is pretrained with input image datasets from different imaging modalities and/or different subregions of an object to be mapped.

7. The method of claim 1, wherein the first input image dataset and the second input image dataset are generated from different imaging modalities or the first input image dataset and the second input image dataset correspond to simulated datasets which are simulated according to different imaging modalities.

8. The method of claim 1, wherein the first input image dataset and the second input image dataset are generated at different time points.

9. The method of claim 1, wherein the first input image dataset and the second input image dataset are generated from different recording angles.

10. The method of claim 1, wherein the difference measure corresponds to a sum of all the differences of image point values of mutually corresponding image points of the output image datasets.

11. A method for registering a first output image dataset with a second output image dataset, wherein the first output image dataset is generated from a first input image dataset and the second output image dataset is generated from a second input image dataset, the method comprising:
providing an algorithm that is trained by providing a first training input image dataset and a second training input image dataset; transforming, by the algorithm, the first training input image dataset into a first training output image dataset and the second training input image dataset into a second training output image dataset, wherein the first output image dataset with the second output image dataset belong to a common image space with a predetermined image point resolution and/or a predetermined contrast range; and optimizing the algorithm such that a difference measure relating to a difference between the first training output image dataset with the second training output image dataset or their representations in a latent space used during transformation is minimized and a respective sum of image point values of each training output image dataset is maximized; and
applying the algorithm to the first input image dataset and the second input image dataset.

12. The method of claim 11, wherein the registration takes place iteratively in that a registration difference measure between the output image datasets is calculated and a position size of one of the output image datasets is changed until the registration difference measure is a minimum.

13. The method of claim 12, wherein the algorithm provides the difference measure for the registration as a registration difference measure.

14. An imaging system comprising:
at least one imaging modality configured to provide a first input image dataset and a second input image dataset; and
an image processing facility configured to register a first output image dataset with a second output image dataset, wherein the first output image dataset is generated from the first input image dataset and the second output image dataset is generated from the second input image dataset, the imaging processing facility configured to:
provide an algorithm that is trained by providing a first training input image dataset and a second training input image dataset; transforming, by the algorithm, the first training input image dataset into a first training output image dataset and the second training input image dataset into a second training output image dataset, wherein the first training output image dataset and the second training output image dataset belong to a common image space with a predetermined image point resolution and/or a predetermined contrast range; and optimizing the algorithm such that a difference measure relating to a difference between the first training output image dataset and the second training output image dataset or their representations in a latent space used during transformation is minimized and a respective sum of image point values of each training output image dataset is maximized; and
apply the algorithm to the first input image dataset and the second input image dataset.

15. The imaging system of claim 14, further comprising two different imaging modalities, each of which provides one of the input image datasets.
